(19) United States
(12) Patent Application Publication
(10) Pub. No.: US 2012/0286481 A1
(43) Pub. Date: Nov. 15, 2012

(54) DEVICE AND PROCESS FOR LIQUID TREATMENT OF WAFER SHAPED ARTICLES

(75) Inventors: Michael PUGGL, SANKT STEFAN (AT); Christian AUFEGGER, WEISSENSTEIN (AT); Karl-Heinz HOHENWARTER, DELLACH/GAILTAL (AT)

(73) Assignee: LAM RESEARCH AG, VILLACH (AT)

(21) Appl. No.: 13/107,651

(22) Filed: May 13, 2011

(51) Int. Cl. B23B 31/02; B23Q 7/00

(52) U.S. Cl. 279/125; 29/559

(57) ABSTRACT

A spin chuck and a process of operating the same display improved resistance to backsplash by provision of a media collecting ring mounted on the spin chuck. The media collecting ring surrounds a wafer to be processed and includes a radially-inwardly extending upper portion having an obliquely-angled downwardly-facing surface positioned above an upper surface of a wafer held in the device. The device moreover includes a stationary chamber surrounding the spin chuck equipped with at least two superposed collecting baffles. During treatment, liquid collected by the media collecting ring is preferably discharged radially outwardly through a series of holes formed in the ring, so as to pass between a pair of the superposed collecting baffles of the chamber.

### BACKGROUND OF THE INVENTION

1. Field of the Invention

The invention relates to a device and a process for liquid treatment of a surface of a wafer-shaped article.

2. Description of Related Art

Liquid treatment includes both wet etching and wet cleaning, wherein the surface area of a wafer to be treated is wetted with a treatment liquid and a layer of the wafer is thereby removed or impurities are thereby carried off. A device for liquid treatment is described in U.S. Pat. No. 4,903,717. In this device the distribution of the liquid may be assisted by the rotational motion imparted to the wafer.

When treatment liquid is flung off the surface of a rotating wafer and collides with a surrounding stationary process chamber wall, backsplash can occur, resulting in droplets of treatment liquid being returned to the wafer surface and a consequent degradation of process performance.

Prior art attempts to limit or prevent backsplash have included the use of a separately-driven liquid catch ring, as described in U.S. Pat. No. 7,122,084 (corresponding to European Patent No. EP 1,532,661); chucks in which the process chamber itself is rotated together with the wafer, as described in U.S. Pat. Nos. 6,027,602 and 6,220,771; and chucks provided with a spin cover for collecting and draining process liquid, as described in U.S. Published Patent Application No. 2009/0101181 (corresponding to European Application No. 2,051,285 A1).

However, the above techniques will in practice often produce devices that are more complicated and expensive than the market will accept, and are moreover unsuited for use in process modules having multiple process levels.

### SUMMARY OF THE INVENTION

A device for liquid treatment of a wafer-shaped article according to the present invention comprises a spin chuck adapted to hold a wafer-shaped article in a predetermined orientation and to spin the wafer-shaped article about an axis perpendicular to a major surface of the wafer-shaped article. The spin chuck comprises a media collecting ring mounted on the spin chuck for rotation therewith, the media collecting ring surrounding a space to be occupied by a wafer-shaped article when positioned in the device and comprising a radially-inwardly extending upper portion having an obliquely-angled downwardly-facing surface positioned above an upper surface of a wafer-shaped article when positioned in the device. The device further comprises a stationary chamber surrounding the spin chuck and comprising at least two superposed collecting baffles.

In preferred embodiments of the device according to the present invention, each of the at least two superposed collecting baffles is associated with a separate drain pipe for separately collecting different liquids.

In preferred embodiments of the device according to the present invention, the spin chuck further comprises a series of gripping pins having surfaces adapted for engaging an edge of a wafer-shaped article to be treated, the surfaces of the gripping pins in a closed position together describing a peripheral edge of a wafer-shaped article to be treated in the device.

In preferred embodiments of the device according to the present invention, the device is a process module for single wafer wet processing of semiconductor wafers.

In preferred embodiments of the device according to the present invention, the gripping pins are arranged in a circular series, and each gripping pin projects upwardly from a respective pivotal base that traverses a lower portion of the media collecting ring.

In preferred embodiments of the device according to the present invention, the spin chuck is axially displaceable relative to the stationary chamber, and the spin chuck is moveable to a first working position in which an upwardly-facing surface of the media collecting ring is at approximately a same level as a radially innermost part of one of the at least two superposed collecting baffles, the media collecting ring in the first working position being spaced radially inwardly from the radially innermost part of that one of the at least two superposed collecting baffles by a gap having a predetermined distance, the predetermined distance preferably being from 0.5 to 5 mm and more preferably from 1 to 3 mm.

In preferred embodiments of the device according to the present invention, the media collecting ring further comprises a series of discharge holes opening on a radially-outwardly facing surface of the media collecting ring, the holes having an aggregate cross-sectional area that is less than an area of the radially-outwardly facing surface of the media collecting ring, preferably no more than 25% of the area of the radially-outwardly facing surface, and more preferably no more than 10% of the area of the radially-outwardly facing surface.

In preferred embodiments of the device according to the present invention, the stationary chamber comprises at least three collector levels and the spin chuck is axially displaceable to a respective working position at each of the at least three collector levels, the media collecting ring at each of the at least three collector levels being disposed between upper and lower collecting baffles, such that liquid discharged through the media collecting ring is confined between a downwardly facing surface of an upper collecting baffle and an upwardly facing surface of a lower collecting baffle.

In preferred embodiments of the device according to the present invention, the spin chuck further comprises at least one lower dispenser for dispensing a liquid onto a lower surface of a wafer-shaped article positioned in the device, and at least one upper dispenser for dispensing a liquid onto an upper surface of a wafer-shaped article positioned in the device.

In preferred embodiments of the device according to the present invention, the spin chuck is adapted to hold a semiconductor wafer of a predetermined diameter, the semiconductor wafer in the predetermined orientation being coaxial with the media collecting ring, and a peripheral edge of the semiconductor wafer in the predetermined orientation being spaced radially inwardly from the media collecting ring by a predetermined distance that is preferably from 2 to 10 mm, and more preferably from 2 to 5 mm.

A process according to the present invention for liquid treatment of a wafer-shaped article comprises positioning a wafer-shaped article on a spin chuck in a predetermined orientation; spinning the wafer-shaped article about an axis perpendicular to a major surface of the wafer-shaped article; and dispensing a treatment liquid onto at least one of an upper and a lower surface of the wafer-shaped article; wherein the spin chuck comprises a media collecting ring mounted on the spin chuck for rotation therewith, the media collecting ring surrounding a space occupied by the wafer-shaped article and comprising a radially-inwardly extending upper portion having an obliquely-angled downwardly-facing surface positioned above an upper surface of the wafer-shaped article; the device further comprising a stationary chamber surrounding the spin chuck and comprising at least two superposed collecting baffles.

In preferred embodiments of the process according to the present invention, each of the at least two superposed collecting baffles is associated with a separate drain pipe for separately collecting different liquids.

In preferred embodiments of the process according to the present invention, the wafer-shaped article is supported by a series of gripping pins having surfaces engaging an edge of the wafer-shaped article, the gripping pins being movable from a closed position in which they are moved radially inwardly into contact with the wafer-shaped article to an open position in which they are moved radially outwardly out of contact with the wafer-shaped article.

In preferred embodiments of the process according to the present invention, the process further comprises discharging treatment liquid collected by the media collecting ring through a series of holes formed in the media collecting ring that open on a radially outwardly facing surface of the media collecting ring.

In preferred embodiments of the process according to the present invention, the process further comprises positioning the spin chuck between a pair of superposed collecting baffles in the stationary chamber such that liquid discharged through the holes in the media collecting ring is confined between a downwardly facing surface of an upper collecting baffle and an upwardly facing surface of a lower collecting baffle.

The present invention thus provides a spin chuck and a process of operating the same that display improved resistance to backsplash by provision of a media collecting ring mounted on the spin chuck. The media collecting ring surrounds a wafer to be processed and includes a radially-inwardly extending upper portion having an obliquely-angled downwardly-facing surface positioned above an upper surface of a wafer held in the device. The device moreover includes a stationary chamber surrounding the spin chuck equipped with at least two superposed collecting baffles. During treatment, liquid collected by the media collecting ring is preferably discharged radially outwardly through a series of holes formed in the ring, so as to pass between a pair of the superposed collecting baffles of the chamber.

### BRIEF DESCRIPTION OF THE DRAWINGS

Other objects, features and advantages of the invention will become more apparent after reading the following detailed description of preferred embodiments of the invention, given with reference to the accompanying drawings, in which:

FIG. 1 is a schematic perspective view from above of a chuck according to an embodiment of the invention, with a wafer in position;

FIG. 2 is a partial axial section through the chuck depicted in FIG. 1, showing also elements of a stationary process chamber that surrounds the chuck; and

FIG. 3 is an enlarged view of the detail III designated in FIG. 2.

### DETAILED DESCRIPTION OF PREFERRED EMBODIMENTS

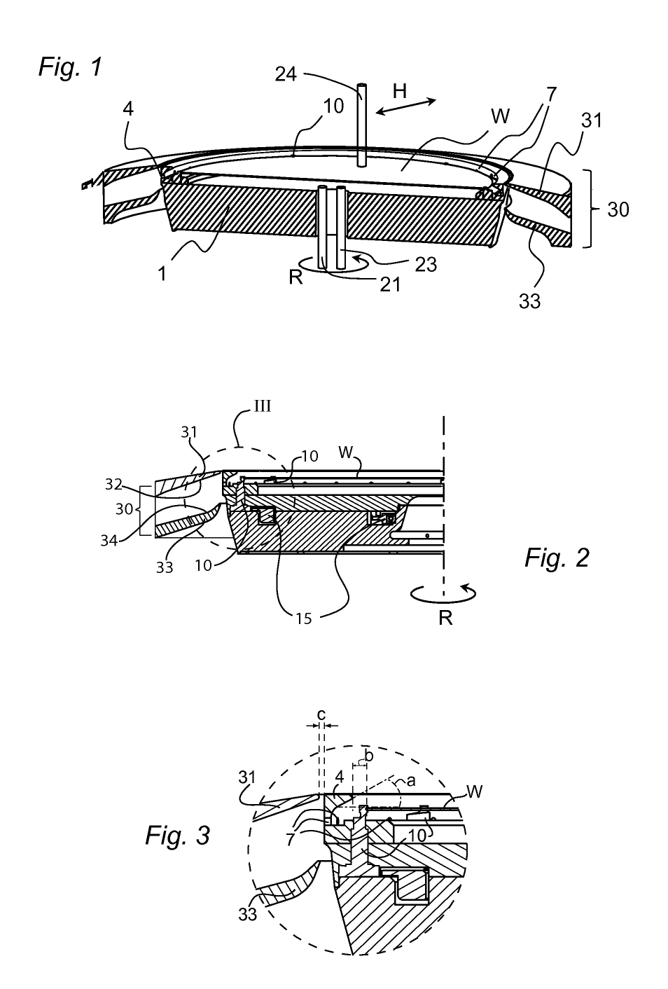

Referring now to the drawings, FIG. 1 depicts a spin chuck 1 that holds a wafer W thereon in a predetermined orientation, which is preferably such that the major surfaces of disposed horizontally or within +20° of horizontal. Spin chuck 1 may for example be a chuck that operates according to the Bernoulli principle, as described for example in U.S. Pat. No. 4,903,717.

Chuck 1 includes a media collecting ring 4, as will be described in greater detail below. The body of chuck 1 is rotated in the direction of arrow R by a motor (not shown), which in turn drives a shaft on which the body of chuck 1 is mounted. Chuck 1 in this embodiment also comprises a circular series of gripping pins 10 for preventing the wafer from sliding laterally off the chuck. Alternatively, gripping pins 10 may also provide subjacent support for wafer W, in which gas the chuck need not operate according to the Bernoulli principle and need not be adapted to supply a gas cushion beneath wafer W.

Chuck 1 furthermore comprises a first lower dispenser 21 for a first liquid to be supplied to the lower surface of the wafer W, and a second lower dispenser 23 for a second liquid to be supplied to the lower surface of the wafer W. An upper liquid dispenser 24 supplies treatment liquid from above, and can incorporate a plurality of different liquid dispensing nozzles for dispensing a variety of different treatment liquids, as described for example in commonly-owned U.S. Pat. No. 7,891,314 (corresponding to WO 2006/008236). Upper liquid dispenser 24 is preferably displaceable radially of the wafer W, to aid in spreading treatment liquid over the entire upwardly facing surface of wafer W as it is rotated on the spin chuck.

Reference numeral 30 denotes a process chamber comprising at least two collecting baffles, with each collecting baffle preferably being associated with a separate drain pipe for separately collecting different liquids, such that the separately collected liquids may be separately recycled or separately drained.

In FIG. 2, the process chamber 30 is shown in more detail. In particular, the process chamber 30 in this embodiment is a multi-level process chamber as described in commonly-owned U.S. Pat. No. 7,837,803 (corresponding to WO 2004/084278). Each level is delimited by a pair of superposed collector baffles. In FIG. 2, baffles 31 and 33 define a first level within the stationary chamber 30, and a similar pair of baffles (not shown) above or below baffles 31 and 33 defines a second level. The chamber preferably comprises at least three such levels.

Spin chuck 1 is not only rotatable about a vertical axis but also, in this embodiment, is axially displaceable relative to the stationary chamber 30 such that the body of spin chuck 1 can be positioned at each of the levels within the chamber. In the depicted first working position, the upper surface of the media collecting ring 4 is more or less flush with the radially innermost part of baffle 31. Treatment liquid discharged radially outwardly through the media collecting ring 4 is thus confined between the lower surface 32 of collecting baffle 31 and the upper surface 34 of the lower collecting baffle 33. In such a multi-level chamber, the discharge and exhaust conditions for both liquids and gases can advantageously be separately and independently controlled as between the different levels. Gas exhaust is handled in the passages formed above the upper baffle 31 of each level, whereas liquid discharge is handled in the spaces between each pair of baffles 31, 33.

Also visible in FIG. 2 are two gripping pins 10 that serve to support the wafer W at least laterally and in some embodiments also bear the full weight of the wafer. Pins 10 can be made as described in commonly-owned U.S. application Ser. No. 12/668,940 (corresponding to WO 2009/010394, or as described in commonly-owned U.S. application Ser. No. 12/642,117, filed Dec. 18, 2009). Pins 10 thus comprise an eccentric uppermost portion that contacts wafer W, projecting from a base that is mounted for pivotal movement about its central axis. In particular, a ring gear 15 is centered on the underside of the chuck upper body, and simultaneously engages via its peripheral gear teeth with gear teeth formed on the base of each of the pins 10. Pins 10 are even distributed about the periphery of spin chuck 1, with at least three and preferably six such pins 10 being provided.

Pins are also described in U.S. Pat. No. 4,903,717, in which each pin projects upwardly from a respective pivotal base. The axes of the contact portion of the pin and its base are vertical but offset from one another such that pivoting of the base causes the associated distal end to travel along a circular arc and hence be adjustable in its radial position. The pivot bases are each provided with gear teeth, which mesh with the teeth of a common gear ring that is coaxial with the axis of rotation of the chuck. Rotation of the gear ring relative to the chuck thus causes all of the pins to move conjointly and to the same extent. That construction permits the pins to be moved radially outwardly for placement or removal of a wafer, and then to be moved radially inwardly to be brought into contact with the peripheral edge of a wafer. Such contact prevents not only lateral displacement of the wafer relative to the chuck, but also relative rotation between the wafer and chuck as the chuck is spun.

In the depicted embodiment, pins 10 pass through openings formed in the base of media collecting ring 4. Those openings are preferably entirely surrounded by the material of the media collecting ring 4, i.e., the openings for pins 10 are defined by closed circular openings traversing the base of ring 4.

Media collecting ring 4 is preferably rigidly secured to the spin chuck 1, and thus rotates with the chuck and also moves axially with the chuck. In particular, media collecting ring is preferably bolted to the upper base body of chuck 1 by a series of bolts (not shown), which pass through the base of media collecting ring as do the gripping pins 10. The bolts securing the media collecting ring 4 to the spin chuck 1 are preferably equal in number and evenly distributed in relation to the pins 10. Thus, in the present embodiment, six pins 10 pass through the base of media collecting ring 4 at 0, 60, 120, 180, 240 and 300 degrees, whereas six connecting bolts pass through the base of media collecting ring 4 at 30, 90, 150, 210, 270 and 330 degrees.

Referring now to FIG. 3, it will be seen that the wafer W, when held by chuck 1, has its outer periphery spaced from the media collecting ring 4 by a distance “b” that is preferably from 2 to 10 mm and more preferably from 2 to 5 mm. Media collecting ring 4 includes an upper portion whose upwardly facing surface is approximately level with baffle 31 and whose downwardly facing surface defines an oblique acute angle “a” relative to the wafer orientation. Such angle is preferably less than 45°, and is more preferably from 15° to 30°. That surface aids in receiving liquid flung from the surface of wafer W by centrifugal force, while inhibiting undesired backsplashing of that liquid.

The distance “b” between media collecting ring 4 and the periphery of wafer W is sufficiently small so as to capture treatment liquid flung radially outwardly from the wafer surface, but sufficiently large to permit a wafer W to be loaded onto the chuck 1, for example utilizing an edge-contact only (ECO) gripper as described in U.S. Pat. No. 5,762,391 (corresponding to EP 0 724 774 B1) whose gripping heads have a diameter slightly less than “b”, such that the wafer W can be lowered to the working position and transferred to pins 10. Furthermore, the distance “b” shall be sufficiently large so that liquid that is collected in the in the collecting ring 4 does not wet the edge of the wafer W.

Media collecting ring 4 furthermore includes a circular series of holes 7 that preferably open on a radially outwardly facing surface of ring 4, as depicted in FIG. 3. Holes 7 permit discharge of the treatment liquid collected by ring 4, into the space between baffles 31 and 33 (or into the space between such other baffle pairs, depending upon the vertical position of chuck 1 relative to stationary chamber 30). However, the aggregate cross-sectional area of holes 7 is small in relation to the surface area of the radially outwardly racing surface of media collecting ring, and therefore the ring 4 continues to protect wafer W from backsplash as the liquid is discharged from the ring.

As is also shown in FIG. 3, the chuck 1 and chamber 30 are configured such that, in the depicted working position, the media collecting ring will be disposed radially inwardly of baffle 31, and spaced therefrom by a distance “c” that is preferably 0.5 to 5 mm, and more preferably from 1 to 3 mm. This also helps to reduce the occurrence and likelihood of backsplash, as does the oblique angle of the underside 32 of baffle 31, which is preferably not greater than the angle “a” and which may be even less than the angle “a”.

It will be appreciated from the foregoing description that the media collecting ring according to the present invention is effective in protecting a wafer from backsplash during liquid treatment on the spin chuck, yet does not require complex mechanisms or bulky additional structures or additional components that would increase the cost of the process module prohibitively.

While the present invention has been described in connection with various preferred embodiments thereof, it is to be understood that those embodiments are provided merely to illustrate the invention, and should not be used as a pretext to limit the scope of protection conferred by the true scope and spirit of the appended claims.

What is claimed is:

1. A device for liquid treatment of a wafer-shaped article, comprising a spin chuck adapted to hold a wafer-shaped article in a predetermined orientation and to spin the wafer-shaped article about an axis perpendicular to a major surface of the wafer-shaped article; wherein the spin chuck comprises a media collecting ring mounted on the spin chuck for rotation therewith, the media collecting ring surrounding a space to be occupied by a wafer-shaped article when positioned in the device and comprising a radially-inwardly extending upper portion having an obliquely-angled downwardly-facing surface positioned above an upper surface of a wafer-shaped article when positioned in the device; said device further comprising a stationary chamber surrounding the spin chuck and comprising at least two superposed collecting baffles.

2. The device according to claim 1, wherein each of said at least two superposed collecting baffles is associated with a separate drain pipe for separately collecting different liquids.

3. The device according to claim 1, wherein said spin chuck further comprises a series of gripping pins having surfaces adapted for engaging an edge of a wafer-shaped article to be treated, the surfaces of the gripping pins in a closed position together describing a peripheral edge of a wafer-shaped article to be treated in the device.

4. The device according to claim 1, wherein said device is a process module for single wafer wet processing of semiconductor wafers.

5. The device according to claim 3, wherein said gripping pins are arranged in a circular series, and each gripping pin projects upwardly from a respective pivotal base that traverses a lower portion of said media collecting ring.

6. The device according to claim 1, wherein said spin chuck is axially displaceable relative to said stationary chamber, and wherein said spin chuck is moveable to a first working position in which an upwardly-facing surface of said media collecting ring is at approximately a same level as a radially innermost part of one of said at least two superposed collecting baffles, said media collecting ring in said first working position being spaced radially inwardly from said radially innermost part of said one of said at least two superposed collecting baffles by a gap having a predetermined distance, the predetermined distance preferably being from 0.5 to 5 mm and more preferably from 1 to 3 mm.

7. The device according to claim 1, wherein said media collecting ring further comprises a series of discharge holes opening on a radially-outwardly facing surface of said media collecting ring, said holes having an aggregate cross-sectional area that is less than an area of said radially-outwardly facing surface of said media collecting ring, preferably no more than 25% of the area of said radially-outwardly facing surface, and more preferably no more than 10% of the area of said radially-outwardly facing surface.

8. The device according to claim 1, wherein said stationary chamber comprises at least three collector levels and wherein said spin chuck is axially displaceable to a respective working position at each of said at least three collector levels, said media collecting ring at each of said at least three collector levels being disposed between upper and lower collecting baffles, such that liquid discharged through said media collecting ring is confined between a downwardly facing surface of an upper collecting baffle and an upwardly facing surface of a lower collecting baffle.

9. The device according to claim 1, wherein said spin chuck further comprises at least one lower dispenser for dispensing a liquid onto a lower surface of a wafer-shaped article positioned in said device, and at least one upper dispenser for dispensing a liquid onto an upper surface of a wafer-shaped article positioned in said device.

10. The device according to claim 4, wherein the spin chuck is adapted to hold a semiconductor wafer of a predetermined diameter, the semiconductor wafer in the predetermined orientation being coaxial with the media collecting ring, and wherein a peripheral edge of the semiconductor wafer in the predetermined orientation is spaced radially inwardly from said media collecting ring by a predetermined distance that is preferably from 2 to 10 mm, and more preferably from 2 to 5 mm.

11. A process for liquid treatment of a wafer-shaped article, comprising positioning a wafer-shaped article on a spin chuck in a predetermined orientation; spinning the wafer-shaped article about an axis perpendicular to a major surface of the wafer-shaped article; and dispensing a treatment liquid onto at least one of an upper and a lower surface of the wafer-shaped article; wherein the spin chuck comprises a media collecting ring mounted on the spin chuck for rotation therewith, the media collecting ring surrounding a space occupied by the wafer-shaped article and comprising a radially-inwardly extending upper portion having an obliquely-angled downwardly-facing surface positioned above an upper surface of the wafer-shaped article; said device further comprising a stationary chamber surrounding the spin chuck and comprising at least two superposed collecting baffles.

12. The process according to claim 11, wherein each of said at least two superposed collecting baffles is associated with a separate drain pipe for separately collecting different liquids.

13. The process according to claim 11, wherein the wafer-shaped article is supported by a series of gripping pins having surfaces engaging an edge of the wafer-shaped article, the gripping pins being movable from a closed position in which they are moved radially inwardly into contact with the wafer-shaped article to an open position in which they are moved radially outwardly out of contact with the wafer-shaped article.

14. The process according to claim 11, further comprising discharging treatment liquid collected by the media collecting ring through a series of holes formed in the media collecting ring that open on a radially outwardly facing surface of the media collecting ring.

15. The process according to claim 14, further comprising positioning the spin chuck between a pair of superposed collecting baffles in the stationary chamber such that liquid discharged through the holes in the media collecting ring is confined between a downwardly facing surface of an upper collecting baffle and an upwardly facing surface of a lower collecting baffle.
